(19) United States
(12) Patent Application Publication
(10) Pub. No.: US 2004/0012810 A1
(43) Pub. Date: Jan. 22, 2004

(54) System and method for presenting images captured at an event during the event

(76) Inventors: William Robert Haas, Fort Collins, CO (US); Kirk Steven Tecu, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/198,874

(22) Filed: Jul. 19, 2002

(51) Int. Cl. G06F 13/00; G06F 3/14; H04N 7/18; H04B 7/00

(52) U.S. Cl. 358/1.15; 348/159; 455/500; 455/66.1

(57) ABSTRACT

Disclosed are systems and methods for providing images captured at a given event. In one embodiment, the systems and methods pertain to transferring image data from at least one digital camera to a central computing device, the image data including images captured during the event, and displaying the captured images at the event for event participants to view.

### BACKGROUND

People often like to memorialize important events or other gatherings by taking pictures. For instance, it is popular to take pictures of friends and family members at parties, weddings, office functions, etc. Due to the advent of disposable cameras, cameras are occasionally distributed to event participants by the event hosts to allow the participants to take pictures at the event. By doing so, more pictures may be obtained and from perspectives that may not be represented if only a few persons (e.g., professional photographers) are taking pictures. For example, disposable cameras are sometimes distributed to wedding guests at wedding receptions so that the guests can take pictures to memorialize the occasion.

Although the distribution of disposable cameras at events such as weddings is a good way of increasing the pool of pictures that are taken during the event, the use of film cameras presents limitations. First, in that film must be developed before pictures may be viewed, the captured images cannot be seen by persons at the event. In fact, it is likely that such persons will not see the pictures, if at all, for several days or weeks after the event. This is unfortunate in that many people would enjoy seeing the pictures during the event, especially when they have come in from out of town for that event. If the pictures were shown at the event, those that otherwise would not have a chance to see them would actually have that opportunity. In addition, those that would like to obtain copies could order them while at the event instead of being forced to wait for a later opportunity to do so, assuming such opportunity even arises for them.

### SUMMARY

Disclosed are methods and apparatus for providing images captured at a given event. In one embodiment, the method comprises transferring image data from at least one digital camera to a central computing device, the image data including images captured during the event, and displaying the captured images at the event for event participants to view.

### BRIEF DESCRIPTION OF THE DRAWINGS

FIG. 1 is a schematic view of an embodiment of a system with which captured images can be displayed during an event.

FIG. 2 is a block diagram of an embodiment of a digital camera shown in FIG. 1.

FIG. 3 is a block diagram of an embodiment of a computing device shown in FIG. 1.

FIG. 4 is a flow diagram that illustrates an embodiment of operation of the system shown in FIG. 1 in facilitating display and ordering of images.

FIG. 5 is a flow diagram that illustrates an embodiment of operation of an image utility shown in FIG. 3 in facilitating display and ordering of images.

### DETAILED DESCRIPTION

As noted above, distribution of film cameras, such as disposable cameras, does not permit viewing of the images captured with the cameras during the event at which the images are captured. As is described in greater detail below, such substantially real-time viewing of images can be facilitated by distributing to event participants digital cameras that are configured to transmit the digitally captured images to a centralized location (e.g., personal computer) that is configured to display the images on an appropriate display device provided at the event. In this manner, images that are captured at the event can nearly immediately be viewed by event participants while still at the event. As is further described below, such display provides event participants, who may not otherwise have the opportunity, to see the images. It also provides the opportunity for the participants to order copies of one or more displayed images while the participants are still at the event.

Disclosed in the following are systems and methods that facilitate the above-described image capture/display/ordering scheme. Although specific systems and methods are described, it is to be understood that these systems and methods are mere embodiments that are provided by way of example to describe the manners in which display and/or ordering of images can be facilitated.

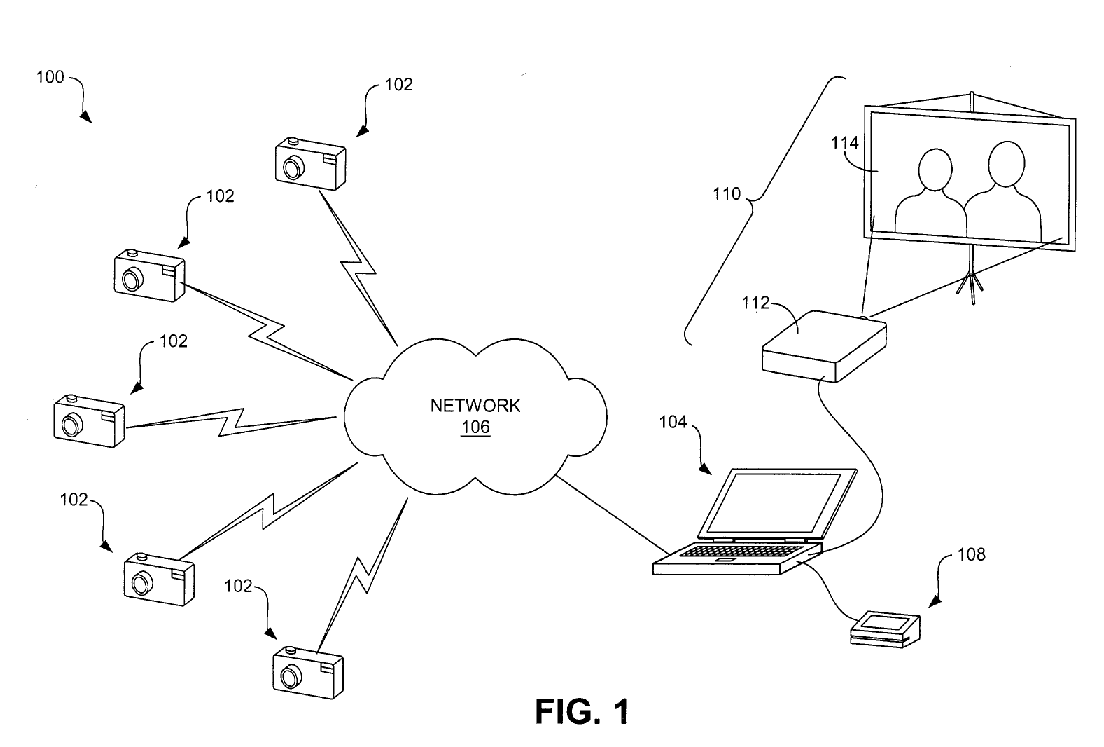

Referring now in more detail to the drawings, in which like numerals indicate corresponding parts throughout the several views, FIG. 1 illustrates an example system 100 that can facilitate substantially real-time display and/or ordering of images. As indicated in FIG. 1, the system 100 generally comprises one or more digital cameras 102 and a central computing device 104. Generally speaking, the digital cameras 102 comprise any digital imaging devices that are capable of digitally capturing images of a viewed scene or object. As is described below, the digital cameras 102 typically are network-enabled such that they can communicate with other devices (e.g., computing device 104) via a network such as network 106.

The computing device 104 can comprise any device that can receive images from the digital cameras 102 and facilitate their display and/or ordering. Typically, the computing device 104 is further capable of storing the images. As indicated in FIG. 1, the computing device can be configured as a notebook personal computer (PC) to permit mobility (i.e., portability) of the system 100. Persons having ordinary skill in the art will recognize from this disclosure that other computing devices could be used such as, for example, a server computer, a desktop PC, etc.

The network 106 typically comprises a wireless local area network (LAN). Optionally, however, the network 106 can comprise a wired LAN and/or a wireless or wired wide area network (WAN). Indeed, in some embodiments, the network 106 may comprise a set of networks that forms part of the Internet. Although wireless network connection is shown in FIG. 1 and explicitly identified herein, it is to be understood that communications between the digital cameras 102 and the computing device 104 can comprise direct (i.e., wired) communications. However, as will become apparent from the following discussions, wireless communications are preferred in many applications in that they permit images to be delivered to the computing device 104 without requiring the image capturer (e.g., event participant) to physically connect a camera 102 to the computing device to transfer data to the computing device.

As is further illustrated in FIG. 1, the system 100 may include a data reading device 108, such as a card reader, that is adapted to read data that identifies an event participant for the purpose of facilitating the image ordering process. The purpose and use of the data reading device 108 are described in greater detail below. In addition, the system 100 may include auxiliary display apparatus 110 including, for example, an image projector 112 and a projector screen 114. Such apparatus 110 is optional to the system 100 but, when provided, facilitates viewing of the captured images by a large number of event participants.

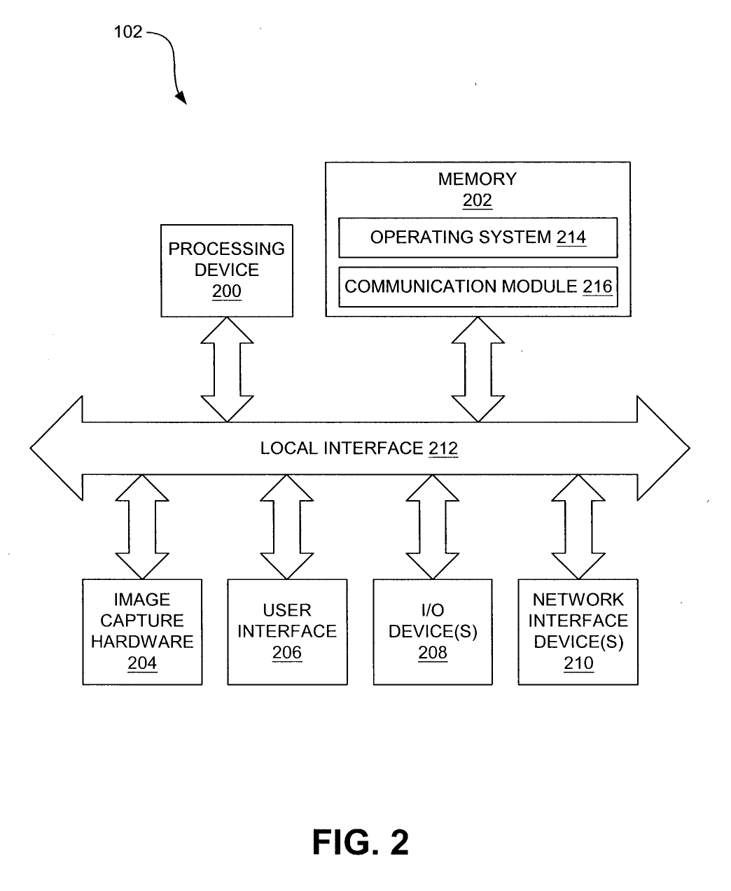

FIG. 2 is a block diagram of an example configuration for the digital camera 102 shown in FIG. 1. As indicated in FIG. 2, the digital camera 102 may comprise a processing device 200, memory 202, image capture hardware 204, a user interface 206, one or more input/output (I/O) devices 208, and one or more network interface devices 210. Each of these components is connected to a local interface 212 that, by way of example, comprises one or more internal buses. The processing device 200 is adapted to execute commands stored in memory 202 and may comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the digital camera 102. The memory 202 may include any one of a combination of volatile memory elements (e.g., random access memory (RAM)) and nonvolatile memory elements (e.g., Flash memory, magnetic random access memory (MRAM)).

The image capture hardware 204 comprises the various components with which the digital camera 102 can capture images. Accordingly, the image capture hardware 204 may comprise, for instance, a shutter, a lens system, a focusing system, one or more photosensitive sensors (e.g., charge-coupled devices (CCDs)), etc.

The user interface 206 comprises interface tools with which the camera settings can be changed and through which the user can communicate commands to the camera 102. This interface 206 typically comprises a shutter release button and one or more function keys. The one or more I/O devices 210 comprise components used to facilitate connection of the digital camera 102 to another device, for instance for purposes of downloading data to the other device. These I/O devices 210 can, for instance, comprise one or more serial, parallel, small system interface (SCSI), universal serial bus (USB), or IEEE 1394 (e.g., Firewire™) connection devices. The network interface devices 210, where provided, comprise the various components used to transmit data over the network 106. By way of example, the network interface devices 210 include a device that facilitates wireless communication, for instance, a short range radio frequency (RF) transmitter, wireless network card, etc.

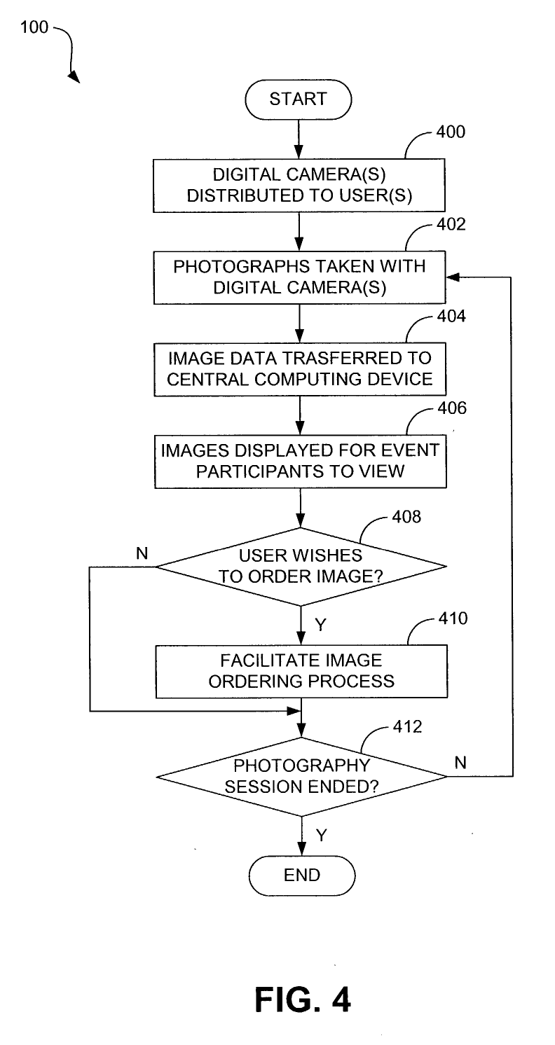

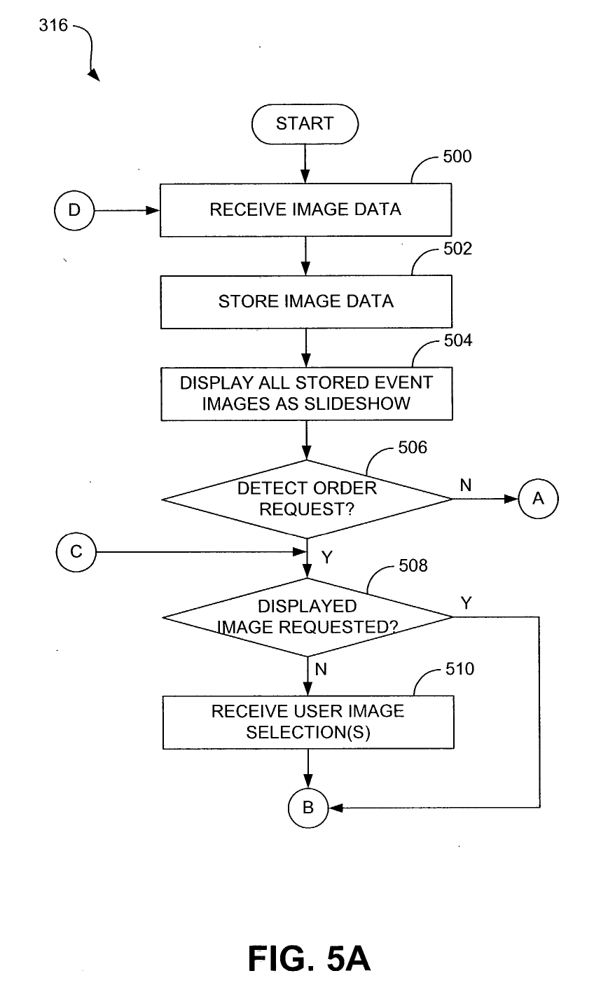

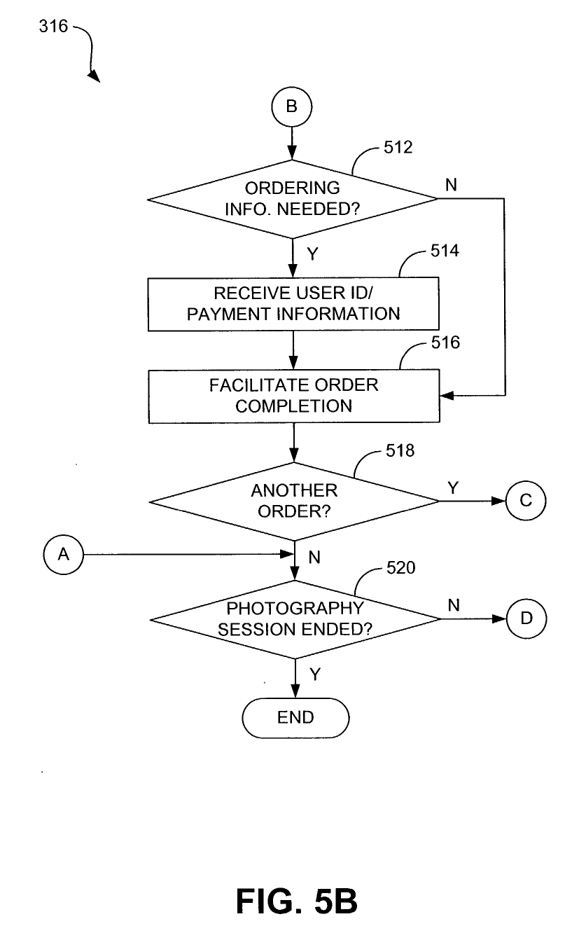

The memory 202 includes various code (e.g., firmware) including an operating system 214 and a communication module 216. The operating system 214 contains the various commands used to control the general operation of the digital camera 102 including those commands related to capturing images as well as those pertaining to implementing user settings commands. The communication module 216 comprises the various code used to facilitate transfer, e.g., via the network interface devices 210, of image data including images captured with the digital camera. Such operation is described below with reference to FIGS. 4-5.

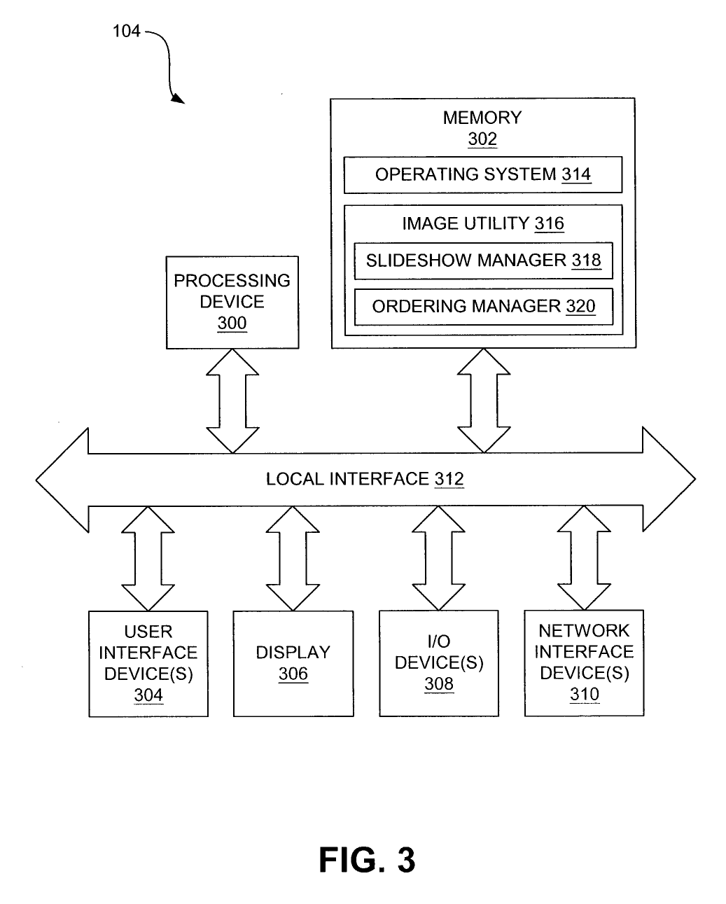

FIG. 3 is a block diagram of an example arrangement for the computing device 104 shown in FIG. 1. As indicated in FIG. 3, the computing device 104 may, for instance, comprise a processing device 300, memory 302, one or more user interface devices 304, a display 306, one or more I/O devices 308, and one or more network interface devices 310, each of which is connected to a local interface 312. The processing device 300 may include any custom made or commercially available processor, a central processing unit (CPU) or an auxiliary processor among several processors associated with the computing device 204, a semiconductor based microprocessor (in the form of a microchip), or a macroprocessor. The memory 302 may include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 304 comprise the components with which the user can interact with the computing device 104. Where the computing device 204 comprises a notebook PC or similar device, these components may comprise those typically used in conjunction with a PC such as a keyboard and mouse. The display 306 may comprise a display typically used in conjunction with a PC such as a computer monitor or liquid crystal display (LCD) screen.

The one or more I/O devices 308 comprise components used to facilitate connection of the computing device 104 to other devices and may comprise one or more serial, parallel, small system interface (SCSI), universal serial bus (USB), or IEEE 1394 (e.g., Firewire™) connection devices. The network interface devices 310 comprise the various components used to transmit and/or receive data over the network 106. By way of example, the network interface devices 312 include a device that can communicate both inputs and outputs, for instance, a network card, modulator/demodulator (e.g., modem), an RF transceiver, a telephonic interface, a bridge, a router, etc. The memory 302 normally comprises various programs in software and/or firmware including an operating system 314 and an image utility 316. The operating system 314 controls the execution of other software/firmware and provides scheduling, input-output control, file and data management, memory management, and communication control and related services. The image utility 316 is used to display images received from the digital cameras 102 and/or facilitate ordering of the images, typically by event participants while still at the event. As indicated in FIG. 3, the image utility 316 may include a slideshow manager 318 that is used to facilitate display of the images captured with the cameras 102, and an ordering manager 320 that is used to facilitate ordering of images. Examples of operation of the image utility 316 are provided in relation to FIGS. 4-5 below.

Various code has been identified above. It is to be understood that this code may be stored on any computer-readable medium for use by or in connection with any computer-related system or method. In the context of this document, a computer-readable medium is an electronic, magnetic, optical, or other physical device or means that can contain or store code (e.g., in the form of a computer program) for use by or in connection with a computer-related system or method. The code may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The term “computer-readable medium” refers to any means that can store, communicate, propagate, or transport the code for use by or in connection with the instruction execution system, apparatus, or device.

The computer-readable medium may be, for example, but is not limited to, an electronic, magnetic, optical, electromagnetic, infrared, or semiconductor system, apparatus, device, or propagation medium. More specific examples (a nonexhaustive list) of computer-readable media include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium may even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, examples of operation of the systems will now be discussed. In the discussions that follow, flow diagrams are provided. It is to be understood that any process steps or blocks in these flow diagrams may represent modules, segments, or portions of code that include one or more executable instructions for implementing specific logical functions or steps in the process. It will be appreciated that, although particular example steps are described, alternative implementations are feasible. Moreover, steps may be executed out of order from that shown or discussed, including substantially concurrently or in reverse order, depending on the functionality involved.

As noted above, it would be desirable to be able to display, and therefore view, images captured at an event during the event, as well as to provide the opportunity for event participants to order displayed images. The above-described systems facilitate this goal by collecting images captured by one or more distributed digital cameras and displaying them for the enjoyment of event participants. FIG. 4 provides an example overview of a such a method. Beginning with block 400 of this figure, one or more digital cameras is/are distributed to users. Who is a “user” will depend upon the context of the use. For example, where pictures are to be taken at a wedding, the users may be wedding guests, where the pictures are to be taken at a party, the users may be partygoers, etc. Most typically, the users will be participants at an event. However, it is noted that others, such as professional photographers, could similarly be users.

Each distributed digital camera may comprise a unique identifier that, as described below, may be used to identify individual images as having been captured with a particular camera. This identifier, when provided, may comprise a default identifier (e.g., “Camera 2”), or a personalized identifier that the user has selected and entered into the camera (e.g., “Table 3”) using the camera user interface. Optionally, some form of security feature can be implemented to deter camera theft. In one arrangement, such a security feature may comprise a disabling feature that disables use of the camera when the camera is removed beyond a delineated geographical area (e.g., predetermined distance from computing device 104) or which in some manner limits operation of the camera to use with a particular system (e.g., system 100). In another arrangement, the security feature may comprise a time limit feature that disables operation of the camera after expiration of a given period of time (e.g., anticipated duration of the event at which the camera is used). In yet another arrangement, the security feature may simply comprise retention of the user's identification card or credit card until return of the camera. Persons having ordinary skill in the art will appreciate that other security options exist and may be implemented to deter camera theft.

Once the digital cameras (assuming that more than one camera was distributed) have been distributed, photographs may be taken with them, as indicated in block 402. Stated in other words, images are captured using the digital cameras. For instance, images may be captured of a bride and groom, event participants, objects of interest at the event, etc. These images may or may not be stored locally at the digital cameras, for example, on a removable memory (e.g., Flash memory) card. Regardless, the image data are transferred to a central computing device (e.g., computing device 104), as indicated in block 404. This transfer of images typically comprises wireless transfer of image data to the central computing device via a network. As noted above, an RF communication scheme could be used to serve this purpose. For instance, an IEEE 802.11, Bluetooth™, or ultrawideband (UWB) network scheme could be used.

After the image data have been transferred to the central computing device, the computing device displays the images from every camera that transferred image data for the event participants to view, as indicated in block 406. Typically, the various received images are displayed in a slideshow format in which each image is displayed for a given period of time (e.g., a few seconds) in succession. In such a scenario, the images may be shown in a chronological order dictated by the time the images where taken (where such information is included with the image data), in a first-in, first-out (FIFO) order, in a last-in, last-out (LILO) order, etc. The display of the images may comprise presentation of the images on the display (e.g., LCD) of the computing device or, alternatively, may comprise display of the images with a display apparatus such as the image projector 112 and a projector screen 114 identified in FIG. 1.

Next, with reference to decision block 408, it can be determined whether a user wishes to order an image. This “user” may comprise a digital camera user identified above, or another user (e.g., event participant) of the system. In any case, the determination normally is made in response to an affirmative action taken on the part of the user. For example, this action may comprise communicating an interest in ordering an image by making a selection or entry on an order form presented on the display of the computing device or by swiping a data source (e.g., data card) though an appropriate data reader (e.g., card reader). As is discussed in greater detail below in relation to FIGS. 5A and 5B, such ordering may comprise placing an order with an appropriate application that executes on the computing device or with a web service that is accessed via the computing device.

If there is no present interest in placing an order for a given image, flow continues down to decision block 410 described below. If, on the other hand, there is interest in ordering an image communicated to the computing device, the computing device facilitates the ordering process. Again, this facilitation may comprise local processing of the order or remote processing of the order by an appropriate web service. Notably, the result of such ordering depends upon what is ordered. Specifically, the user may be provided with the option of receiving a hardcopy of the image immediately if a local printer is available, receiving a hardcopy of the image through the mail, or receiving an electronic copy of the image via a network connection (e.g., through email). In any case, the ordering process typically comprises receipt of identification and/or payment information of the user.

Next, referring to decision block 412, a determination is made as to whether the photography session has ended. What constitutes the end of the session may depend upon the application. Normally, however, the end of the session will at least occur by the end of the event. Such termination of the photography session may be achieved, for example, using a time-out scheme in which the digital cameras no longer capture and/or transfer images and/or the central computing device no longer accepts new images for display and/or ordering. Where a time-out scheme is not used, the photography session may be terminated manually (e.g., retrieval of the cameras, halting of the computing device image application, etc.). If the session has not ended, flow returns to block 402 and the image capture/transfer process continues in the manner described above. If the session has ended, however, flow for the method is likewise terminated.

FIGS. 5A and 5B provide an example of operation of the image utility 316 shown in FIG. 3 in facilitating substantially real-time display and/or ordering of images captured at an event. Beginning with block 500 of FIG. 5A, image data are received by the image utility 316 as images are transferred (i.e., transmitted) from the one or more distributed digital cameras. The various images received by the image utility 316 are stored, as indicated in block 502, for instance on the computing device hard disk. By way of example, the image data are stored in a given image display file created or reserved for the event at which the images are being captured. In addition to the raw data that form the various images, the image data may include an identifier of the camera that captured each image as well as an image number associated with each image. For instance, if a given image is the third image captured with a camera having an identifier “Johnson family,” the image data for that particular image may include the information “Johnson family #3” as metadata for the image. In addition, the image data may further comprise a time stamp that identifies when each image was captured for purposes of ordering the images chronologically, if desired. Furthermore, the stored image data may further comprise information regarding when each image was received by the image utility 316 for purposes of ordering newly received images.

Once the image data are stored, all stored images may be displayed as a slideshow, as indicated in block 504. As noted above, this slideshow may be chronologically ordered such that the oldest images are shown first through to the most recent images. Such a display format may be desirable for many events in that it will provide a chronology of things that occur during the course of the event. This chronology can be determined by the image utility 316, and more particularly by the slideshow manager 318, by referencing the stored time stamp associated with each given image. Optionally, the slideshow manager 318 can be configured to display the images in a random or other order, as desired.

As noted above, display may comprise presenting the images on the display of th& computing device or with display apparatus such as an image projector and projector screen. In either case, the displayed images may, optionally, include the identifiers associated with the image to facilitate ordering of the image and to identify who (or at least which camera) captured the image. In such a scenario, the identifier may be shown in a corner of the displayed image.

Referring now to decision block 506, the image utility 316 determines whether an order request is detected. As noted above, this detection may occur in response to the user selecting and/or entering items using an order form presented with the display of the computing device or by swiping an appropriate data source, such as a data card, through a reading device, such as a card reader. If no such order request is detected, flow continues to decision block 508 of FIG. 5B described below. If an order request is detected, however, flow continues on to decision block 506 at which it can be determined whether the displayed image is requested. In such a case, the order request detection will typically comprise detection of the reading of data from the user's data source. In such a scenario, data sources (e.g., cards) can be distributed to each event participant, whether taking pictures or not. Through a registration process that occurs prior to the event or at the beginning of the event, the data stored on the data sources (e.g., a code) is associated with the particular event participant and may, for instance, be associated with various information concerning the participant such as the participant's identity, mailing address, email address, payment information, image preferences, etc.

Where such a data source is read while a particular image is being displayed, the image utility 316 can, by default, assume that the user wishes to order that particular image. In such a case, if all necessary identification and payment information is on file for that participant, the only other action needed on the part of the participant is to confirm the order by, for instance, selecting an “Agree” command (or equivalent) via the computing device. To accommodate situations in which several participants may want a copy of a particular image (e.g., a “good” picture), the ordering of an image in the manner described above can restart an image display clock to provide others with time to swipe their own data sources through the reader. For example, if each image of the slideshow is presented for three seconds, the image can be displayed for ten seconds after each order placed for that image. Once ten seconds have elapsed with no new orders, the next image may be displayed and then each image again shown for only three seconds each.

If a displayed image request is not identified, flow continues to block 510 at which the user manually indicates which image or images are desired, for instance by entering the image identifiers displayed with the images via the computing device, and the image selections are received. Next, with reference to decision block 512 of FIG. 5B, it can be determined whether any ordering information is still needed. If, as described above, all such information is on file and is accessed when, for instance, the user swipes a data card through a card reader, no such information will typically be necessary and flow will continue down to block 516 described below. If, on the other hand, such information is needed, it is received, as indicated in block 514. Again, this information may be input via the computing device.

Once all necessary information is possessed and accessed by the image utility 316, flow continues to block 516 at which the image utility 316 facilitates order filling. The nature of this filling depends upon the required action. Where the system includes a local printer (not shown) and the user participant has selected a “print image” option, filling the order may comprise sending a print job to the printer to generate a hardcopy of the selected image. Where the user has selected a “mail hardcopy image” option, filling the order may comprise logging the order such that a hardcopy can later be generated and mailed to the address provided by the user. Where the user has selected an “email electronic copy” option, order filling may comprise emailing an electronic copy of the selected image to the email address the user has provided. Notably, the user's preference may be indicated in preferences the user identified in the data source registration process. Alternatively, multiple reading devices may be provided, each applicable to a different type of order, for example, one pertaining to immediate and local printing, one pertaining to later printing and physical mailing, and one pertaining to emailing of electronic copies.

With reference now to decision block 518, it can be determined whether there is another order request. If so, flow returns to block 508 of FIG. 5A described above. If not though, flow continues to decision block 520 at which it is determined whether the photography session has ended. As noted above in relation to FIG. 4, what constitutes the end of the session may depend upon the application, but typically will at least occur by the end of the event. If the photography session has ended, flow for the method is terminated. If the session has not ended, flow continues back to block 500 of FIG. 5A and resumes from that point.

As can be appreciated from the above discussion, the use of the disclosed systems permits substantially real-time display of images captured at an event, thereby ensuring that a larger audience has the opportunity to see the images and that everyone has a chance to see the images earlier than they otherwise would. In addition, ordering of the images is facilitated by such display. It is noted that, although the ordering process is described as being completed by the image utility 316 residing on the computing device, it will be appreciated by persons having ordinary skill in the art that this utility, and therefore functionality may instead be provided on a remote computing device (e.g., server) web service accessed via the local computing device. Regardless, however, the flow described above with reference to blocks 508-518 is the same in either scenario. Ordering could be performed in other ways, for example manually, as by a user listing desired images on an order form and handing the completed form to an event organizer who later prints the desired images, mails/emails the images to the user and bills the user for the prints.

While particular embodiments have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing images captured at a given event, comprising:
transferring image data from at least one digital camera to a central computing device, the image data including images captured during the event; and
displaying the captured images at the event for event participants to view.

2. The method of claim 1, wherein the step of transferring image data comprises wirelessly transmitting the image data to the central computing device.

3. The method of claim 1, wherein the step of transferring image data comprises wirelessly transmitting image data from a plurality of digital cameras to the central computing device, each digital camera being operated by a participant of the event.

4. The method of claim 1, wherein the step of transferring image data comprises transferring captured images and a camera identifier that identifies the camera that captured each image.

5. The method of claim 4, wherein the step of transferring image data further comprises transferring time stamps that indicate when each image was captured by the at least one digital camera.

6. The method of claim 1, wherein the step of displaying the captured images comprises displaying the images as a substantially real-time slideshow.

7. The method of claim 6, wherein the step of displaying the captured images further comprises displaying the captured images in chronological order within the slideshow according to the time when the image was captured as indicated by the transferred image data.

8. The method of claim 1, further comprising facilitating ordering of a displayed image during the event.

9. The method of claim 8, wherein the step of facilitating ordering comprises reading data from a data source presented by an event participant.

10. The method of claim 9, wherein the data source comprises a data card that contains data associated with at least one of stored identification information and payment information.

11. The method of claim 1, wherein the step of facilitating ordering comprises at least one of sending a print job to a local printer, logging an order for a hardcopy of the image to be mailed to the participant, and emailing an electronic copy of the image to the participant.

12. A system for providing images captured at a given event, comprising:
means for capturing images during the event;
means for transmitting the images to a central device at the event; and
means for displaying the images at the event such that event participants may view the captured images substantially real-time.

13. The system of claim 12, wherein the means for capturing images comprise a digital camera.

14. The system of claim 12, wherein the means for transmitting the images comprise a wireless communication device.

15. The system of claim 12, wherein the means for transmitting comprise a radio frequency communication device.

16. The system of claim 12, wherein the means for displaying comprise a central computing device.

17. The system of claim 16, wherein the means for displaying further comprise an image projector that is in communication with the computing device.

18. A digital camera that is configured to facilitate substantially real-time display of images captured with the camera during a given event, the camera comprising:
a processing device;
image capture hardware;
memory including a communication module that is configured to facilitate transmission of image data comprising images captured with the digital camera and at least one of a time stamp indicating when each image was captured and an identifier that identifies each captured image as having been captured with the digital camera; and
a wireless communication device that is configured to wirelessly transmit the image data.

19. An image utility stored on a computer-readable medium, comprising:
logic configured to receive image data from at least one digital camera distributed at a given event;
logic configured to store the image data; and
logic configured to display images contained in the image data during the event such that event participants can view the images substantially real-time.

20. The image utility of claim 19, wherein the logic configured to display images is configured to display the images in a slideshow, the images being chronologically ordered within the slideshow according to metadata contained in the image data.

21. The image utility of claim 19, further comprising logic configured to facilitate ordering of a captured image.

22. The image utility of claim 21, wherein the logic configured to facilitate ordering comprises logic configured to receive and access at least one of user identification information and payment information.

23. The image utility of claim 21, further comprising logic configured to facilitate at least one of printing of a hardcopy of an ordered image, mailing of a hardcopy of an ordered image, and emailing of an electronic copy of an ordered image.
